(19) United States
(12) Patent Application Publication
(10) Pub. No.: US 2006/0291654 A1
(43) Pub. Date: Dec. 28, 2006

(54) Apparatus and method for descrambling transport stream data

(75) Inventors: Yong-Seong Jo, Jeonju-city (KR); Han-Seung Koo, Daejeon (KR); O-Hyoung Kwon, Daejeon (KR); Chieteuk Ahn, Daejeon (KR)

Correspondence Address: MAYER, BROWN, ROWE & MAW LLP, 1909 K STREET, N.W., WASHINGTON, DC, 20006, US

(73) Assignee: Electronics and Telecommunications Research Institute

(21) Appl. No.: 11/510,609

(22) Filed: Aug. 28, 2006

Related U.S. Application Data
(62) Division of application No. 10/133,482, filed on Apr. 29, 2002.

(30) Foreign Application Priority Data
Dec. 28, 2001 (KR) 2001-86505

(51) Int. Cl. H04N 7/167

(52) U.S. Cl. 380/239

(57) ABSTRACT

Disclosed is an apparatus and method for descrambling transport stream (TS) data, the descrambling apparatus including: a TS packet input unit for determining from the value of a header of TS packet data whether the TS packet data are scrambled, and outputting determination results and the TS packet data; a descramble controller for applying a control signal to the TS packet input unit for the TS packet input unit to read the TS packet data, and outputting a scramble determination signal of a corresponding state based on the determination results; and a descrambler for determining from the state of the scramble determination signal whether the TS packet data from the TS packet input unit are scrambled, and determining whether to descramble the TS packet data.

### CROSS REFERENCE TO RELATED APPLICATION

This application is a divisional of U.S. Ser. No. 10/133,482, filed on Apr. 29, 2002. This application, in its entirety, is incorporated herein by reference.

### BACKGROUND OF THE INVENTION

(a) Field of the Invention

The present invention relates to an apparatus and method for descrambling transport stream (hereinafter, referred to as “TS”) data. More specifically, the present invention relates to an apparatus and method for descrambling TS packet data fed into a so-called POD (Point of Deployment) unit that is a receiver of a digital cable broadcasting system.

(b) Description of the Related Art

In the current digital cable broadcasting system, the digital broadcasting stream is compressed according to MPEG (Motion Picture Expert Group)-2, which is a standard for data compression of moving pictures, and it is carried on the TS through in-band channels. The TS is fed into a POD unit by 8 bits in parallel so that the POD unit judges whether or not the TS is scrambled. The POD unit comprises PCMCIA (Personal Computer Memory Card International Association) cards divided for descrambling of the received broadcasting signals, identification of subscribers, and the like.

When it is determined from the value of a transport scrambling control field present in the TS packet header whether or not the TS packet is scrambled, a demultiplexer built in the POD unit aligns the TS packet data on the basis of sync bytes. Subsequently, the demultiplexer sends scrambled TS packet data to a descrambler, and non-scrambled TS packet data directly to a remultiplexer.

The descrambler descrambles the TS packet data in reverse order of scrambling, and sends the restored TS packet data to the remultiplexer.

The remultiplexer converts the demultiplexed TS packet data fed into the POD unit to a single TS packet and sends it to a host. Namely, the POD unit determines whether or not the TS packet data on the in-band channels are scrambled, and restores the scrambled TS packet data by descrambling.

In the above-stated operation that involves judging whether the TS packet data are scrambled, and selecting and descrambling the scrambled TS packet data, a different device is used to process the TS packet data for descrambling if the TS packet data are scrambled. This causes a time delay between operations of processing scrambled data and non-scrambled data, and hence errors in the processing time of the respective TS packet data occur.

### SUMMARY OF THE INVENTION

It is an object of the present invention to provide a descrambling apparatus and method capable of descrambling TS packet data that is fed into a POD unit that is the receiver of a subscriber in the digital cable broadcasting system, using the same processing device irrespective of whether the TS packet data are scrambled, thereby reducing errors in the processing time of the TS packet data.

It is another object of the present invention to provide a descrambling apparatus and method capable of simplifying a complex structure for individually processing scrambled data and non-scrambled data.

In one aspect of the present invention, there is provided a descrambling apparatus, which is to descramble transport stream (TS) data used in a receiver of a digital cable broadcasting system, the descrambling apparatus including: a TS packet input unit for determining from the value of a header of the externally applied TS packet data whether or not the TS packet data are scrambled, and outputting the result of determination and the TS packet data; a descramble controller for applying a control signal to the TS packet input unit for the TS packet input unit to read the TS packet data, and outputting a scramble determination signal of a corresponding state based on the result of determination output from the TS packet input unit; and a descrambler for determining from the state of the scramble determination signal output from the descramble controller whether or not the TS packet data applied from the TS packet input unit are scrambled, and controlling whether to descramble the TS packet data.

The descrambler extracts control words (CW) from an entitle management message (EMM) and an entitle control message (ECM) and then descrambles the input TS packet data using the control words.

Also, the descrambler sets the value of the control words so as to output the TS packet data as if they are scrambled, and a descrambling operation is performed, when it is determined from the scramble determination signal that the TS packet data are not scrambled. Here, as many control words are given as there are blocks of the TS packet data, and all the blocks of the TS packet data are individually descrambled at the same time.

The descrambler further includes a block shift register for sequentially shifting the input TS packet data, and it applies the TS packet data fed into the block shift register when it is determined from the scramble determination signal that the TS packet data are not scrambled.

In another aspect of the present invention, there is provided a descrambling method, which is to descramble transport stream (TS) data used in a receiver of a digital cable broadcasting system, the descrambling method including: (a) reading externally applied TS packet data, and determining whether or not the TS packet data are scrambled; (b) extracting control words from an entitle management message and an entitle control message that are externally applied; and (c) descrambling the TS packet data using the extracted control words.

The step (c) includes: (c-I) setting the value of the control words so as to output the TS packet data as if they are not scrambled, when the TS packet data are determined to be not scrambled; (c-II) setting the value of the control words so as to descramble the TS packet data, when the TS packet data are determined to be scrambled; and (c-III) descrambling the TS packet data using the set control words.

In particular, the step (C-III) includes individually descrambling all the blocks of the TS packet data at the same time.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an apparatus for descrambling TS data in accordance with an embodiment of the present invention;

FIGS. 2a and 2b are illustrations showing the internal structure of a descrambler in accordance with an embodiment of the present invention;

FIG. 3 is a flow chart showing the operation of a descramble controller in accordance with an embodiment of the present invention; and

FIGS. 4a and 4b are flow charts showing the operation of the descrambler in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

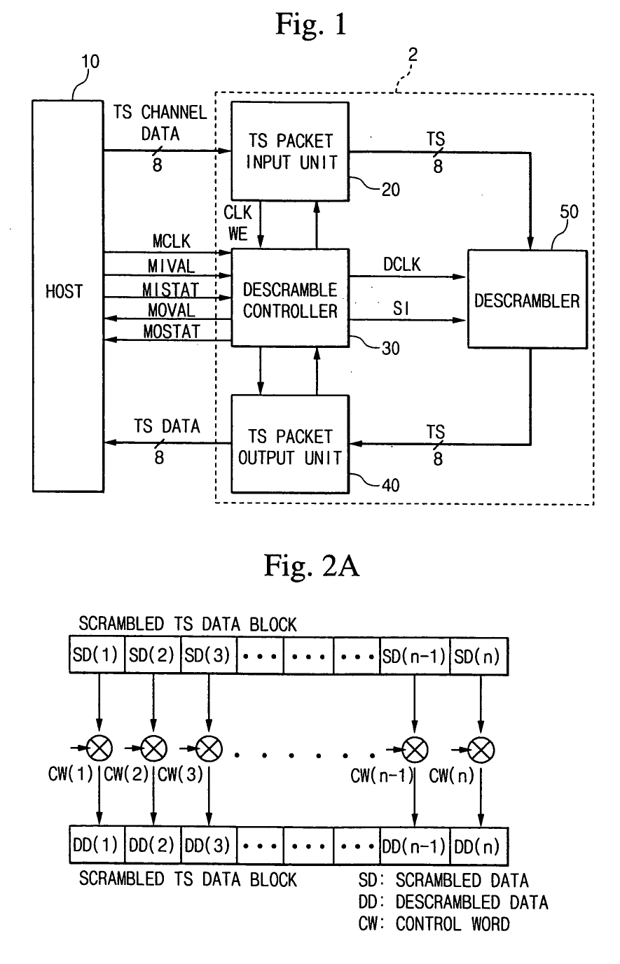

FIG. 1 is a block diagram of an apparatus for descrambling TS data in accordance with an embodiment of the present invention, and a description of the apparatus for descrambling TS data in a POD unit will now be given with reference to FIG. 1.

The embodiment of the present invention comprises a host 10 for transmitting TS packet data to a subscriber, and a POD unit 2 for receiving the TS packet data from the host 10.

The POD unit 2 comprises a descramble controller 30 for receiving a clock signal MCLK and control signals MIVAL and MISTAT, and controlling descrambling of the TS packet data applied from the host 10 based on the state of the clock signal MCLK and the control signals MIVAL and MISTAT; a TS packet input unit 20 for reading and storing the TS packet data externally applied by 8 bits in parallel based on a clock signal CLK and a control signal WE received from the descramble controller 30, determining whether or not the TS packet data are scrambled, sending the result of determination to the descramble controller 30, and outputting the input TS packet data; a descrambler 50 for descrambling the TS packet data based on a clock signal DCLK and a scramble identification signal SI received from the descramble controller 30; and a TS packet output unit 40 for reading and storing non-scrambled TS packet data received from the descrambler 50 based on the clock signal DCLK of the descramble controller 30, and outputting them to the host 10 based on control signals MOSTAT and MOVAL of the descramble controller 30.

With this structure, the descramble controller 30 outputs the clock signal CLK and the control signal WE to the TS packet input unit 20, and controls the TS packet input unit 20 to read the TS packet data applied in parallel from the host 10, and to determine from the value of a 2-bit packet header whether or not the TS packet data are scrambled. Subsequently, the descramble controller 30 determines the data input state of the TS packet input unit 20 based on the state of the clock signal MCLK and the control signals MIVAL and MISTAT received from the host 10, and then checks, based on the control signal of the TS packet input unit 20, whether or not the TS packet data are scrambled.

The descrambler 50 determines, from the clock signal DCLK and the scramble identification signal SI of the descramble controller 30, whether or not the TS packet data received from the TS packet input unit 20 are scrambled, and controls to descrambe of the scrambled data according to the state of the TS packet data. Then the descrambler 50 outputs the descrambled data to the TS packet output unit 40.

The TS packet output unit 40 outputs the descrambled TS data to the host 10 under the control of the descramble controller 30, so that the host 10 transmits the TS data to the subscriber.

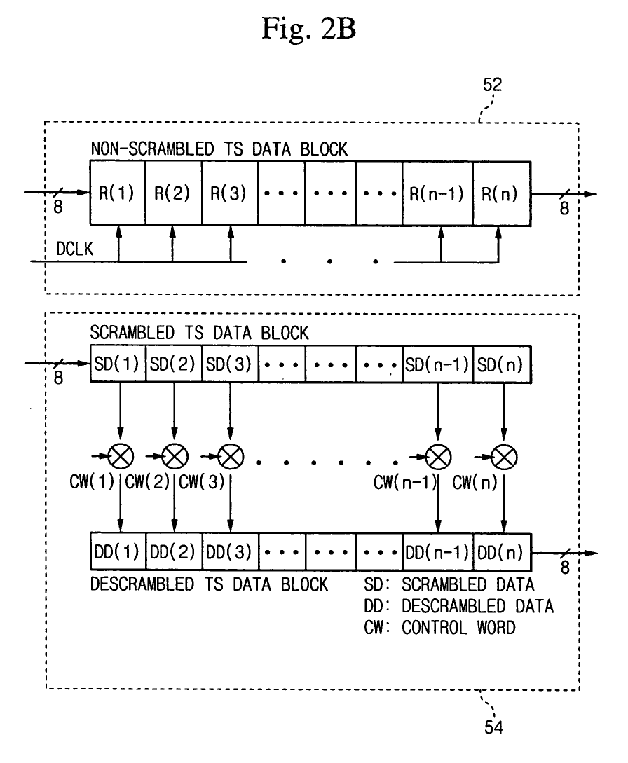

Now, a detailed description will be given to the control of the descramble controller 30 and the descrambler 50, with reference to FIGS. 2, 3, and 4.

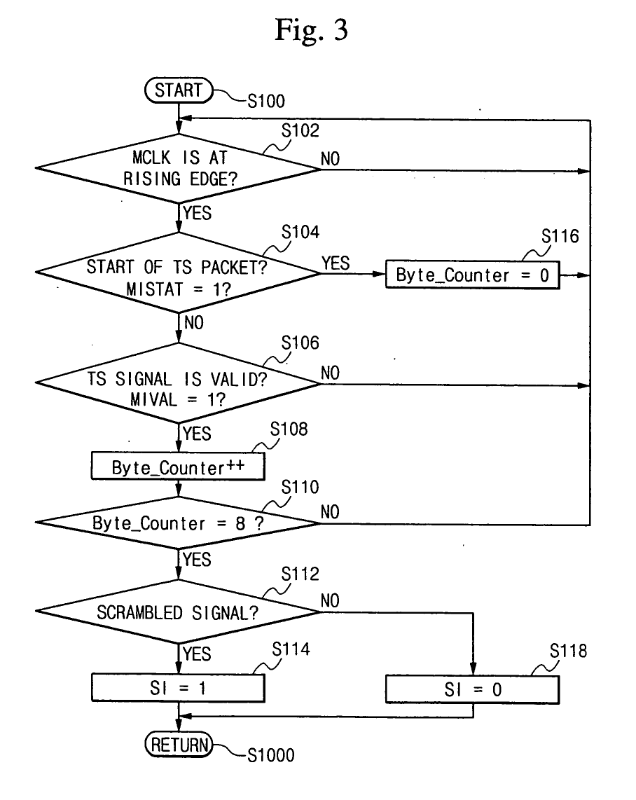

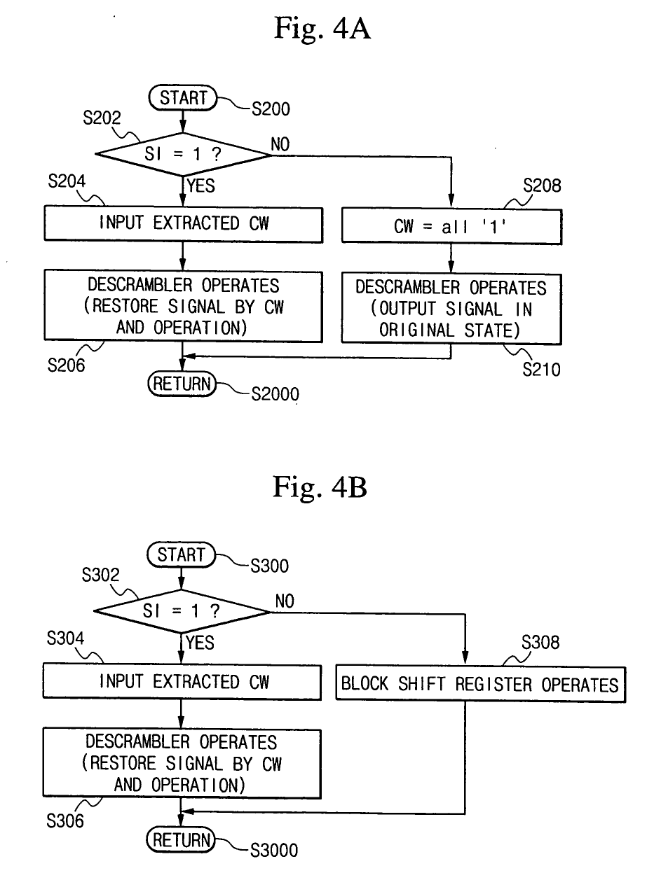

FIGS. 2a and 2b are illustrations showing the internal structure of the descrambler in accordance with an embodiment of the present invention, FIG. 3 is a flow chart showing the operation of the descramble controller in accordance with an embodiment of the present invention, and FIGS. 4a and 4b are flow charts showing the operation of the descrambler in accordance with an embodiment of the present invention.

The descramble controller 30 outputs the clock signal CLK and the control signal WE to the TS packet input unit 20 so that the TS packet input unit 20 can read the TS packet data from the host 10. After reading the TS packet data output by the host 10, the TS packet input unit 20 determines the state of the TS packet data and makes the descrambler 50 descramble the TS packet data according to the state of the TS packet data.

First, the operation of the descramble controller 30 will be described with reference to FIG. 3.

At the beginning of the operation, in step 100, the descramble controller 30 reads the clock signal MCLK applied from the host 10 and determines whether or not the clock signal MCLK is at a rising edge, in step 102.

When the clock signal MCLK is not at the rising edge, the descramble controller 30 repeats the step 102 to determine the state of the clock signal MCLK.

Otherwise when the clock signal MCLK is at the rising edge, the descramble controller 30 reads a data input start signal MISTART that is applied from the host 10 and indicates the start of the TS packet data, and determines the state of the signal, in step 104.

When the data input start signal MISTAT is “1”, the descramble controller 30 determines that the host 10 starts to input one TS data packet, and initializes the value of an internal counter for automatically counting the number of bytes to “0” so as to determine the input state of the TS packet data. Subsequently, the descramble controller 30 returns to step 102 to determine the state of the clock signal MCLK.

Otherwise, when the data input start signal MISTAT is not “1” but it is “0”, the descramble controller 30 determines that the TS packet data are already input from the host 10, and reads a TS packet validity signal MIVAL applied from the host 10 to determine the state of the TS packet validity signal MIVAL, in step 106.

The TS packet validity signal MIVAL indicates whether or not the TS packet data communicated between the host 10 and the POD unit are valid. Accordingly, when the TS packet validity signal MIVAL is “0”, the descramble controller 30 determines that the currently input TS packet data are not valid, and returns to step 100.

Otherwise, when the TS packet validity signal MIVAL is “1”, the descramble controller 30 determines that the TS packet data are valid, and increases the value of the counter by “1”, in step 108.

Subsequently, the descramble controller 30 checks whether the value of the counter reaches“8”, and determines whether or not the TS packet data, each of which is fed into the TS packet input unit 20 block by block whenever the pulse signal MCLK is applied, are all input.

When the value of the counter does not reach“8”, the descramble controller 30 returns to step 102 so that the TS packet data can be input from the host 10 based on the clock signal MCLK.

Otherwise, when the value of the counter reaches“8”, the descramble controller 30 determines that 64 bits of data of one TS packet are all fed into the TS packet input unit 20. Namely, the descramble controller 30 descrambles the TS packet data by 64-bit blocks and determines that 64 bits of data are all fed into the TS packet input unit 20 when eight TS data packets are input by 8 bits in parallel.

In step 112, the descramble controller 30 determines from a determination signal received from the TS packet input unit 20 whether or not the TS packet data are scrambled.

In the embodiment of the present invention, the TS packet input unit 20 stores, in the internal memory device such as a buffer, the TS packet data received from the host 10 by 8 bits in parallel. Subsequently, the TS packet input unit 20 aligns the TS packet data in the size of 188 bytes with respect to sync bytes, and determines whether or not the TS packet data are scrambled.

Whether or not the TS packet data are scrambled is determined from a 2-bit transport scrambling control field present in the TS packet header. The TS packet input unit 20 determines, based on the value of the 2-bit field, whether or not the TS packet input data are scrambled. That is, the TS packet data are determined to be scrambled when the 2-bit field has a value of “10” or “11”, and to be not scrambled when the 2-bit field has a value other than “10” or “11”.

The TS packet input unit 20 outputs the result of determination based on the value of the transport scrambling control field to the descramble controller 30.

As such, the descramble controller 30 determines from the control signal applied from the TS packet input unit 20 whether or not the current input TS packet data are scrambled.

When the TS packet data are scrambled, the descramble controller 30 sets the value of a scramble identification signal SI to “1” and outputs it to the descrambler 50, in step 1 14.

Otherwise when the TS packet data are not scrambled, the descramble controller 30 sets the value of the scramble identification signal SI to “0” and outputs it to the descrambler 50, in step 118.

The descrambler 50 determines whether to descramble the TS packet data applied from the TS packet input unit 20, based on the state of the scramble identification signal SI of the descramble controller 30.

Now, a description will be given to an operation of the descrambler 50 with reference to FIGS. 2a and 2b, and FIGS. 4a and 4b.

An example of the descrambler 50 in accordance with an embodiment of the present invention will be described with reference to FIGS. 2a and 4a.

First, the descrambler 50 reads the scramble identification signal SI applied from the descramble controller 30 and determines the state of the signal SI, in step 202.

When the scramble identification signal SI is “1”, the descrambler 50 extracts as many corresponding control words CW as there are TS data packets from an entitle management message (EMM) and an entitle control message (ECM), in step 204.

The ECM is a message containing an encoded control word so that only entitled subscribers can receive scrambled broadcasting signals from the digital CATV system. The ECM is transmitted through in-band channels in the open cable system. The EMM is a message containing data related to entitlement management so that only the subscribers entitled to paid broadcasting contents that have a key for decoding the encoded control word can receive broadcasting signals. The EMM is transmitted through out-of-band channels in the open cable system. The generation and transmission technologies of these messages are known to those skilled in the art and will not be described.

Subsequently, the descrambler 50 performs a predetermined descrambling operation for the respective TS packet data using the extracted control words CW to restore the TS packet data to the original state, and outputs the descrambled TS packet data to the TS packet output unit 40, in step 206. The descrambler 50 individually performs the descrambling operation using the control words CW for every TS packet data.

When the scramble identification signal SI is not “1”, i.e., the input TS packet data are not scrambled, the descrambler 50 sets the value of all the control words CW to “1”, in step 208. Namely, the descrambler 50 sets the value of the control words CW so that the TS packet data are output in the state as they are originally input, when the previously established descrambling operation is performed.

Then the descrambler 50 descrambles the TS packet data using the control words CW, all of which are set to “1”, and outputs the descrambled TS packet data to the TS packet output unit 40, in step 210.

As described above, even in the case the descrambler 50 descrambles the TS packet data that are not scrambled, the descrambler 50 outputs data to the TS packet output unit 40 in the same state as the data are originally input, according to the control word CW set to “1”.

The structure of the descrambler 30 is schematically shown in FIG. 2a.

As shown in FIG. 2a, the respective TS packet data and the respective control words CW are dealt with simultaneously so as to output the original packet data that are not scrambled.

Now, another example of the descrambler in accordance with an embodiment of the present invention will be described with reference to FIGS. 2b and 4b.

In this embodiment, when the scramble identification signal SI output from the descramble controller 30 is “1”, i.e., the input TS packet data are determined to be scrambled, the TS packet data are fed into a descramble operator 54 and processed in the same manner as in steps 204 and 206 of FIG. 2a, of which the operation will not be described.

Otherwise, when the scramble identification signal Si is not “1”, i.e., the input TS packet data are found to be not scrambled, the descrambler 50 inputs the TS packet data to a built-in block shift register 52, in step 308.

The shift register 52 sequentially shifts the TS packet data input based on the clock signal DCLK output from the descramble controller 30 and outputs them to the TS packet output unit 40.

As such, the non-scrambled TS packet data can also be processed by the descrambler 50.

The signals MOSTAT and MOVAL shown in FIG. 1 are respectively a data output start signal and a TS packet validity signal, which are control signals related to the data output operation between the TS packet output unit 40 and the host 10.

As described above, the embodiment of the present invention descrambles the TS packet data using the same descrambler 50 irrespective of whether or not the TS packet data are scrambled.

According to the present invention, the compressed TS packet data fed into the POD unit through in-band channels in the digital cable broadcasting system are processed by the same descrambler for the same descrambling time irrespective of whether or not they are scrambled, thereby reducing errors in the processing time of the TS packet data.

Using the same descrambler reduces the difference in the processing time between scrambled TS packet data and non-scrambled TS packet data, and thus eliminates a separate processing operation or device and reduces the error of the processing time, which reduces economic loss and processing time and hence increases processing efficiency.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1-17. (canceled)

18. A descrambling method, which is to descramble transport stream (TS) data used in a receiver of a digital cable broadcasting system, the descrambling method comprising:
(a) reading externally applied TS packet data, and determining whether or not the TS packet data are scrambled;
(b) extracting control words from an entitle management message and an entitle control message that are externally applied;
(c) descrambling the TS packet data using the extracted control words when it is determined that the TS packet data are scrambled; and
(d) applying the TS packet data into a block shift register when it is determined from the scramble determination signal that the TS packet data are not scrambled.

19. A descrambling method, which is to descramble transport stream (TS) data used in a receiver of a digital cable broadcasting system, the descrambling method comprising:
(a) reading externally applied TS packet data, and determining whether or not the TS packet data are scrambled;
(b) extracting control words from an entitle management message and an entitle control message that are externally applied;
(c) descrambling the TS packet data using the extracted control words when it is determined that the TS packet data are scrambled; and
(d) setting the value of the control words so as to output the TS packet data as it is, even though a descrambling operation is performed, when it is determined that the TS packet data are not scrambled, and descrambling the TS packet data using the set control words.

20. The descrambling method as claimed in claim 19, wherein as many control words are given as there are blocks of the TS packet data.

21. The descrambling method as claimed in claim 20, wherein the steps (c) and (d) comprise individually descrambling all the blocks of the TS packet data at the same time.

22. The descrambling method as claimed in claim 18, wherein the step (c) comprises individually descrambling all the blocks of the TS packet data at the same time.

23. (canceled)
